(19) United States
(12) Patent Application Publication
(10) Pub. No.: US 2016/0158977 A1
(43) Pub. Date: Jun. 9, 2016

(54) SHAPE MEMORY POLYMER (SMP) FLOW MEDIA FOR RESIN INFUSION

(71) Applicant: Spirit AeroSystems, Inc., Wichita, KS (US)

(72) Inventor: William Tod Ross, Cheney, KS (US)

(73) Assignee: Spirit AeroSystems, Inc., Wichita, KS (US)

(21) Appl. No.: 14/562,909

(22) Filed: Dec. 8, 2014

(51) Int. Cl. B29C 43/56; B29C 59/02; B29C 43/36

(52) U.S. Cl. CPC B29C 43/56; B29C 43/3642; B29C 59/02; B29C 2043/561; B29C 2043/3644; B29C 2043/3647; B29K 2101/00

(57) ABSTRACT

A system and method of vacuum assisted resin transfer molding (VARTM) using a reconfigurable material, such as shape memory polymer (SMP), for a caul sheet or a forming tool. The reconfigurable material may have a rough or non-smooth, deformed configuration to serve as a flow media during resin transfer, but may be triggered to return to a smooth memory shape at composite cure temperatures at least high enough to place the reconfigurable material into a malleable state. Thus, a surface of the composite material facing the reconfigurable material will have a substantially smooth finish following curing thereof. The rough or non-smooth deformed configuration may be created by embossing or otherwise forming various patterns into the reconfigurable material in the malleable state, and holding this pattern while triggering the reconfigurable material back to a rigid state for use during resin transfer.

### BACKGROUND

Parts made of composite materials are used in a variety of industries, including the aircraft industry. Vacuum assisted resin transfer molding (VARTM) is a composite manufacturing process in which dry fibers of composite material are laid on a tool beneath a nylon vacuum bag and vacuum sealed while liquid resin is drawn through the composite material with a vacuum pump. Traditionally, a flow media or resin distribution media, made of nylon, plastic, or metal and having a high permeability, is placed over the composite material to allow resin to flow over it and subsequently be evenly dispersed throughout the composite material. A breather cloth made of fiberglass or peel-ply may be placed beneath the nylon vacuum bag to help pull resin through the material and allow air to be evacuated from between the nylon vacuum bag and the tool. The nylon vacuum bag may then be placed over the composite material, flow media, and breather cloth, and sealed to the tool with chromate vacuum bag tape. A vacuum inlet and a vacuum outlet in the nylon vacuum bag and/or in the tool may allow the liquid resin to be pulled through the composite material. Once the liquid resin is distributed throughout the composite material and the vacuum bag is compressed against the composite material by vacuum force, the part may be cured by heat to harden the composite part.

A flow media used during resin transfer must be porous to allow the passage of resin and must be locally stiff to resist crushing caused by consolidation pressure applied to the composite material by the vacuum bag. Materials that are most effective as flow media generally have rough surfaces. If left in place during cure, this can result in the transfer of the flow media's rough surface to the cured composite part. This is undesirable, because many composite parts, particularly outer surfaces of aircraft parts, must have smooth surfaces. To compensate for the rough surface left behind on the cured composite part, some manufacturing processes involve sanding the cured composite part to smooth its rough surface. This is a labor-intensive task and can result in undesirable thickness variations or waviness in the surface of the cured composite part.

### SUMMARY OF THE INVENTION

Embodiments of the present invention solve the above-mentioned problems by providing a method of vacuum assisted resin transfer molding (VARTM) of composite material that does not leave a rough surface on a resulting composite part. One embodiment of the invention provides a method of VARTM and curing of a composite material using a reconfigurable part made of shape memory polymer (SMP) or reshapeable thermoplastic material that may change between a rigid state and a malleable state. The method may include a step of assembling an air-tight chamber around an uncured composite material. The air-tight chamber may include an impermeable membrane, the reconfigurable part in the rigid state, a resin inlet, and a vacuum outlet. The reconfigurable part may also have at least one surface in a non-smooth, deformed configuration placed against a surface of the composite material. The method may then include the steps of pulling resin from the resin inlet into the airtight chamber via the vacuum outlet, then curing the composite material at a cure temperature sufficient to trigger the reconfigurable part into the malleable state. The surface of the reconfigurable part in the non-smooth, deformed configuration may automatically return to a smooth configuration when triggered to the malleable state.

Another embodiment of the invention provides a method of VARTM and curing of a composite material using a reshapeable caul sheet made of shape memory polymer (SMP) or reshapeable thermoplastic material that may change between a rigid state and a malleable state. The method may include the steps of triggering the reshapeable caul sheet into the malleable state, deforming the reshapeable caul sheet into a non-smooth, deformed configuration, then triggering the reshapeable caul sheet into the rigid state while retained in the non-smooth, deformed configuration. Next, the method may include the steps of placing composite material onto a rigid forming tool, placing the reshapeable caul sheet in the non-smooth deformed configuration and the rigid state against the composite material, covering the reshapeable caul sheet and the composite material with an impermeable membrane, and then sealing the impermeable membrane to the rigid forming tool, creating a substantially airtight chamber between the rigid forming tool and the impermeable membrane. The airtight chamber may include a resin inlet and a vacuum outlet formed therethrough. The method may also include the steps of pulling resin from the resin inlet into the airtight chamber via the vacuum outlet connected to a vacuum source, and then curing the composite material at a temperature at least high enough to trigger the reshapeable caul sheet back into the malleable state. The reshapeable caul sheet may have a memory shape including a smooth surface facing the composite material and may automatically return from the non-smooth, deformed configuration to the memory shape when triggered to the malleable state.

Yet another embodiment of the invention provides a method of VARTM and curing of a composite material using a reshapeable forming tool made of shape memory polymer (SMP) or reshapeable thermoplastic material that may change between a rigid state and a malleable state. The method may include the steps of triggering the reshapeable forming tool into the malleable state, deforming a surface of the reshapeable forming tool into a non-smooth, deformed configuration, then triggering the reshapeable forming tool back into the rigid state while retained in the non-smooth, deformed configuration. Then the method may include the steps of placing composite material onto the reshapeable forming tool in the rigid state and the non-smooth, deformed configuration, covering the composite material with an impermeable membrane, and sealing the impermeable membrane to the reshapeable forming tool, creating a substantially airtight chamber between the reshapeable forming tool and the impermeable membrane. The airtight chamber may also include a resin inlet and a vacuum outlet formed therethrough. Next, the method may include the steps of pulling resin from the resin inlet into the airtight chamber via the vacuum outlet connected to a vacuum source, then curing the composite material at a temperature at least high enough to trigger the reshapeable forming tool back into the malleable state. The reshapeable forming tool may have a memory shape including a smooth surface facing the composite material and may automatically return from the non-smooth, deformed configuration to the memory shape when triggered to the malleable state.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic cross-sectional elevation view of a vacuum assisted resin transfer molding (VARTM) system constructed in accordance with various embodiments of the present invention, illustrating a reshapeable caul sheet in a non-smooth, deformed configuration;

FIG. 2 is a schematic cross-sectional elevation view of the VARTM system of FIG. 1, illustrating the reshapeable caul sheet in a memory shape having a smooth configuration;

FIG. 3 is a schematic cross-sectional elevation view of a cured composite part and the reshapeable caul sheet of FIG. 1;

FIG. 4 is a flow diagram of steps of a method for resin infusion and curing of composite material using the reshapeable caul sheet of FIG. 1, in accordance with various embodiments of the present invention;

FIG. 5 is a schematic cross-sectional elevation view of an alternative embodiment of a VARTM system constructed in accordance with various embodiments of the present invention, illustrating a reshapeable forming tool in a non-smooth, deformed configuration;

FIG. 6 is a schematic cross-sectional elevation view of the VARTM system of FIG. 5, illustrating the reshapeable forming tool in a memory shape having a smooth configuration;

FIG. 7 is a schematic cross-sectional elevation view of a cured composite part formed by the VARTM system of FIG. 5; and

FIG. 8 is a flow diagram of steps of a method for resin infusion and curing of composite material using the reshapeable forming tool of FIG. 5, in accordance with various embodiments of the present invention.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

### Embodiment 1

### Reshapeable Caul Sheet

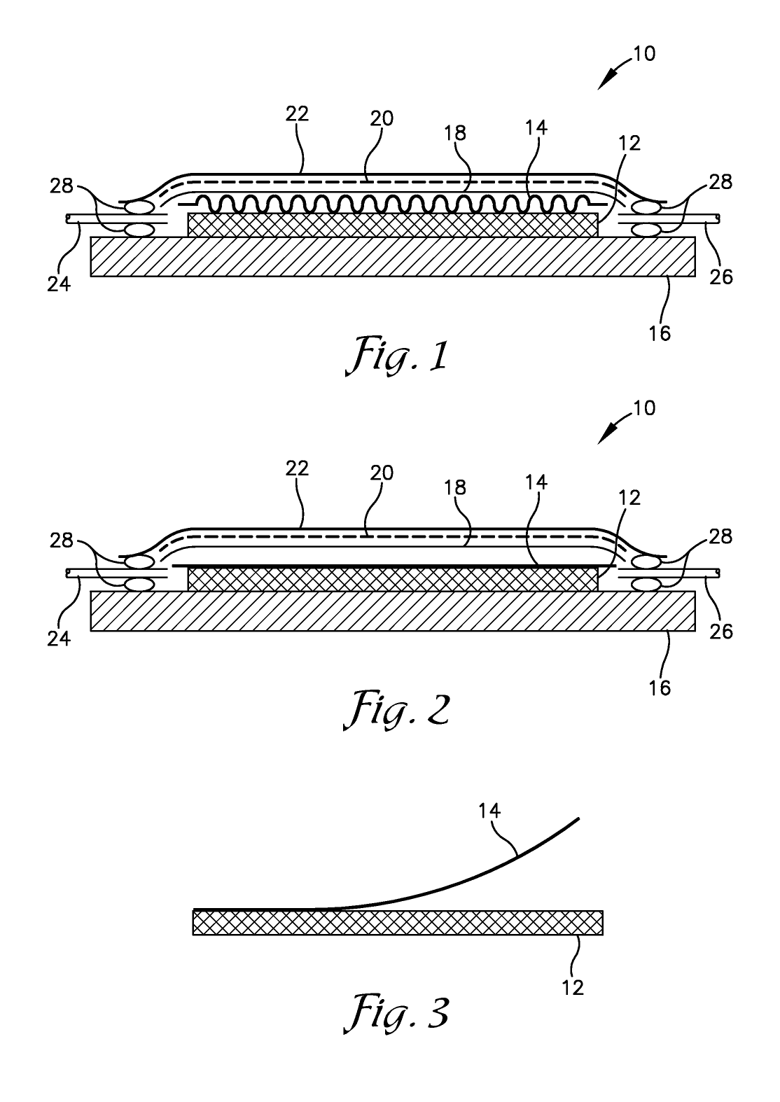

A vacuum assisted resin transfer molding (VARTM) system 10 constructed in accordance with embodiments of the present invention is shown in FIGS. 1-4. Embodiments of the invention are configured for distributing liquid resin throughout a composite material 12 and then curing the composite material 12 into a rigid, cured composite part having smooth outer surfaces. The VARTM system 10 may comprise a reshapeable caul sheet 14 made of shape memory polymer (SMP) material and/or a reshapeable thermoplastic material, as well as a rigid forming tool 16, release film 18, a breather 20, and an impermeable membrane 22, also referred to as a vacuum bag. The VARTM system 10 may further comprise a resin inlet 24, a vacuum outlet 26, and/or adhesive tape 28 for creating a substantially air-tight seal between the forming tool 16 and the impermeable membrane 22.

The SMP material used to form the reshapeable caul sheet 14 may be reinforced or unreinforced SMP material. Specifically, the SMP material used to form the reshapeable caul sheet 14 may be an epoxy, an epoxy-based SMP, a styrene copolymer based SMP or any other type or combination of SMPs, such as cyanate ester, polyurethane, polyethylene homopolymer, styrene-butadiene, polyisoprene, copolymers of stearyl acrylate and acrylic acid or methyl acrylate, norbonene or dimethaneoctahydronapthalene homopolymers or copolymers, and malemide. For example, the SMP material may be any of the SMPs described in U.S. Pat. No. 7,422,714, U.S. Pat. No. 6,986,855, U.S. Pat. No. 7,276,195, U.S. Patent Application Publication No. 2008/0021188, U.S. Patent Application Publication No. 2008/0021166, and/or U.S. Patent Application Publication No. 2008/0269420, all of which are incorporated herein in their entireties by reference. However, numerous other types of SMPs exist and can be tailored to meet specific tolerances and temperature requirements.

The SMP material may be cast into any memory shape. For example, the reshapeable caul sheet 14 may be cast into a thin, smooth sheet having typical dimensions of a traditional caul sheet. The dimensions of the memory shape of the reshapeable caul sheet 14 may have an area at least as large as the composite material 12. Once cast, the reshapeable caul sheet 14 can be triggered to change modulus between a rigid state and a malleable state, but is configured to naturally return to its memory shape when in the malleable state, unless acted upon by other outside forces.

The modulus of various SMP materials can be changed through several different methods, such as a temperature change, an electric current, water, and/or light. However, the exemplary methods described herein disclose the use of temperature changes to transform the reshapeable caul sheet 14 from a malleable state to a rigid state and vice versa. Nevertheless, any of the above-listed triggers for changing the modulus of the reshapeable caul sheet 14 may be used for the VARTM methods described herein without departing from the scope of the invention.

A glass transition temperature (T_{g}) of an SMP material is defined herein as a threshold temperature at and/or above which that SMP material begins to transition to a lower modulus state, becoming soft and/or malleable in order to be deformed. Therefore, the reshapeable caul sheet 14 of the present invention may be configured to begin to become flexible and formable when it is heated above its T_{g} and to become rigid when cooled to a temperature below its T_{g}. If the reshapeable caul sheet 14 is deformed at a temperature above T_{g} and then held in that deformed state as its temperature drops below T_{g}, then the reshapeable caul sheet 14 hardens in that deformed configuration.

For example, the reshapeable caul sheet 14 may be deformed, molded, or otherwise shaped to have at least one rough surface. The rough surface may be texturized and/or may include a network of small channels or recesses formed into the surface through which the resin may flow, such as a wavy surface texture, zigzag patterned channels, crisscross-patterned channels, or any pattern embossed into one or more surfaces of the reshapeable caul sheet 14. The texture or channels formed into the reshapeable caul sheet 14 may be sized so as to allow resin to flow over a surface of the composite material 12 without significant amounts of the composite material 12 entering the texture cavities or channels.

The reshapeable caul sheet 14 may be molded or embossed into the deformed configuration while the reshapeable caul sheet 14 is in the malleable state, then cooled or otherwise changed back to the rigid state in this deformed configuration, such as the wavy configuration illustrated in FIG. 1. This deformed configuration of the reshapeable caul sheet 14 may be positioned to face the composite material 12 during VARTM, such that the resin may be evenly distributed throughout the composite part via the cavities and channels formed by the rough surface of the reshapeable caul sheet 14. When heated again, the SMP apparatus 12 may generally return to its originally-cast memory shape unless otherwise acted on by another force. For example, the reshapeable caul sheet 14 may return to its memory shape having a smooth surface similar to a traditional caul sheet.

Note that although the modulus change of the reshapeable caul sheet 14 may begin at T_{g}, there may be a range of transition temperatures through which the reshapeable caul sheet 14 may become increasingly malleable. Furthermore, the SMP material of the reshapeable caul sheet 14 may have any T_{g} appropriate for the uses and methods described herein. In some embodiments of the invention, T_{g} may be approximately equal to the curing temperature for the composite material 12, such that the reshapeable caul sheet 14 may return to its smooth-surfaced memory shape during curing of the composite part. Furthermore, T_{g} may be greater than the temperature used during VARTM or vacuum resin infusion of the composite material 12 such that the reshapeable caul sheet 14 remains rigid during VARTM in its deformed or wavy configuration.

While the reshapeable caul sheet 14 may be designed to have any T_{g}, in some example embodiments of the invention, T_{g} may be a temperature between 100° F. and 700° F. Specifically, T_{g} may be a temperature between 100° F. and 200° F., 200° F. and 300° F., or between 300° F. and 400° F. More specifically, T_{g} may be a temperature between 125° F. and 175° F., 250° F. and 300° F., or 350° F. and 400° F. In one embodiment of the invention, T_{g} of the reshapeable caul sheet 14 may be approximately equal to 143° F., 275° F., or 375° F. The reshapeable caul sheet 14 may become increasingly malleable when heated through a transition range of temperatures beginning at or centered around T_{g} and may gradually harden to its rigid state when cooled through the transition range of temperatures to a temperature at or below T_{g}.

The rigid forming tool 16 may have at least one substantially-smooth forming surface onto which the composite material 12 is placed. The rigid forming tool 16 may have any shape or configuration desired for forming the composite material 12 into a cured composite part having desired dimensions and curvatures. For example, the rigid forming tool 16 may be made of substantially thick, non-malleable titanium, steel, aluminum, or any other material configured to remain rigid during composite material cure under autoclave heat and pressure.

The release film 18 may be any release agent known in the art for preventing adhesion of the breather 20 and/or impermeable membrane 22 to the reshapeable caul sheet 14 during autoclave heat and pressure. That is, the release film 18 may be placed over the reshapeable caul sheet 14, between the reshapeable caul sheet 14 and the breather 20 or the impermeable membrane 22. Furthermore, in some embodiments of the invention, release film 18 may be applied between the composite material 12 and the reshapeable caul sheet 14 to prevent adhesion therebetween during autoclave cure.

The breather 20 may be a breather cloth made of fiberglass, peal ply, or any other breather material known in the art to prevent the impermeable membrane 22 from pressing too tightly against the release film 18, the reshapeable caul sheet 14, and/or the composite material 12, which could restrict flow of the resin during VARTM. However, the breather 20 may be omitted from some embodiments of the VARTM system 10 without departing from the scope of the invention.

The impermeable membrane 22 may be any flexible impermeable sheet or vacuum bagging material known in the art of composite manufacturing. Specifically, the impermeable membrane 22 may be configured to compress and consolidate the composite material 12 during autoclave cure when sealed to the rigid forming tool 16. The impermeable membrane 22 may have an outer surface facing away from the rigid forming tool 16, an inner surface opposite of the outer surface and facing toward the rigid forming tool 16, and a plurality of edges.

The resin inlet 24 and the vacuum outlet 26 may be formed through the impermeable membrane 22, formed through the rigid forming tool 16, and/or formed between the impermeable membrane 22 and the rigid forming tool 16. The resin inlet and the vacuum outlet 26 may comprise tubes, pipes, and/or on/off valves for allowing resin and/or atmosphere therethrough. The resin inlet 24 may be fluidly coupled to a resin source, such as a resin reservoir with the resin for VARTM residing therein. The vacuum outlet 26 may be fluidly coupled to a vacuum source and configured to suction atmosphere or air and thus pull the resin from the resin reservoir toward the vacuum outlet 26.

The adhesive tape 28 may be any adhesive tape known in the art and configured for creating a substantially air-tight seal between the forming tool 16 and the impermeable membrane 22. In other embodiments of the invention, the adhesive tape 28 may be replaced with other types of sealing devices configured for sealing the impermeable membrane 22 to the forming tool 16 without departing from the scope of the invention.

In use, a method of forming a composite part by VARTM using the reshapeable caul sheet 14 may generally include the steps of placing the composite material 12 onto the rigid forming tool 16, placing the reshapeable caul sheet 14 in the deformed configuration and the rigid state against the composite material 12, and covering the reshapeable caul sheet 14 with the release film 18, the breather 20, and/or the impermeable membrane 22. The impermeable membrane 22 may be sealed to the rigid forming tool 16, creating a substantially airtight chamber between the rigid forming tool 16 and the impermeable membrane 22. Next, the resin may be pulled through the resin inlet 24 in a direction toward the vacuum outlet 26 and evenly dispersed across the composite material 12 between the reshapeable caul sheet 14 and the composite material 12. After the resin is dispersed across the composite material 12, the composite material 12 may be cured in an autoclave or oven. The cure temperatures may trigger the reshapeable caul sheet 14 back to the malleable state, such that the reshapeable caul sheet 14 returns to its memory shape having a smooth surface. Thus, a surface of the resulting composite part contacting the reshapeable caul sheet 14 also remains smooth after cure.

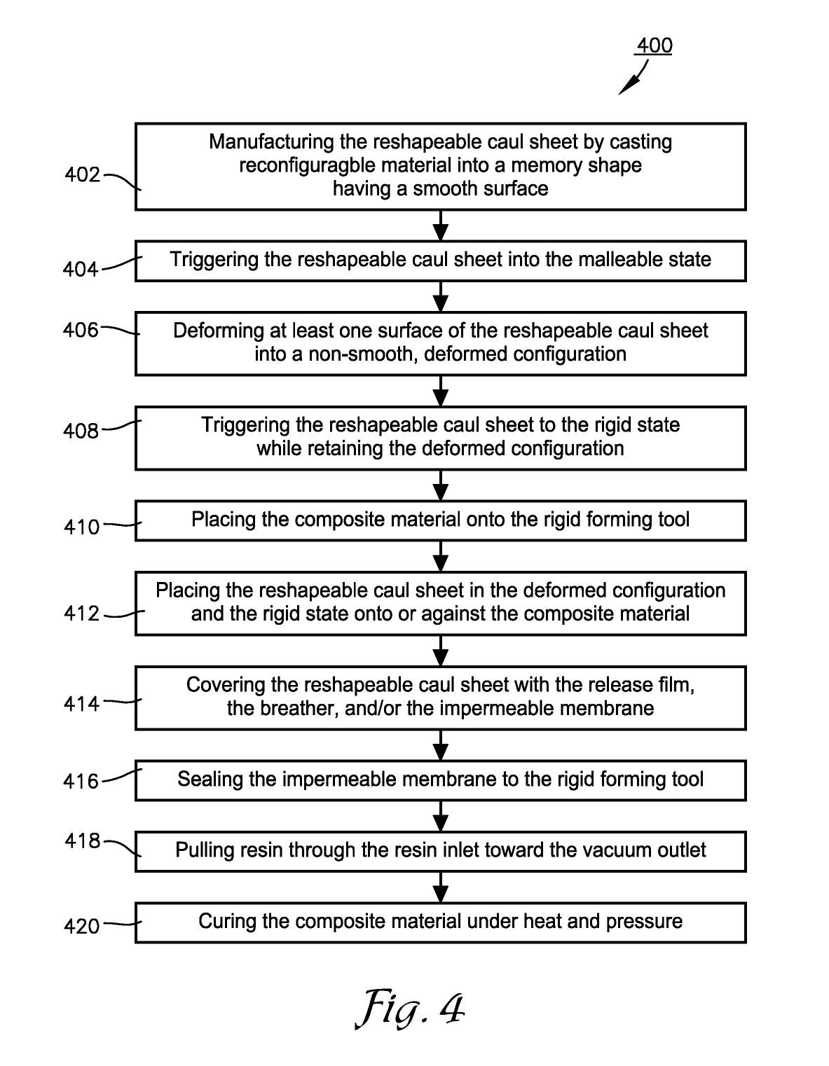

Method steps for resin-infusing and curing the composite material 112 with the reshapeable caul sheet 14 will now be described in more detail. Specifically, FIG. 4 illustrates steps in a method 400 for forming a composite part using the reshapeable caul sheet 14, in accordance with various embodiments of the present invention. The steps of the method 400 may be performed in the order as shown in FIG. 4, or they may be performed in a different order. Furthermore, some steps may be performed concurrently as opposed to sequentially. In addition, some steps may not be performed.

The method 400 may include a step of manufacturing the reshapeable caul sheet 14 by casting reconfigurable material into a memory shape having at least one substantially smooth surface, as depicted in block 402. As described above, the reshapeable caul sheet 14 may be made of SMP material or reshapeable thermoplastic materials having similar properties to the SMP material. Next, the method 400 may include triggering the reshapeable caul sheet 14 into the malleable state, as depicted in block 404, and deforming at least one surface of the reshapeable caul sheet 14 into a non-smooth, deformed configuration, as depicted in block 406 and illustrated in FIG. 4.

The method 400 may then include a step of triggering the reshapeable caul sheet 14 to the rigid state while retaining the deformed configuration, as depicted in block 408. For example, a tool used for embossing a texture or pattern of indentations into at least one surface of the reshapeable caul sheet 14 while heated in the malleable state may remain pressed against the reshapeable caul sheet 14 while the reshapeable caul sheet 14 is cooled below T_{g}. Once the reshapeable caul sheet 14 is completely rigid, the tool used for embossing may be removed away from the reshapeable caul sheet 14. In some embodiments of the invention, a release agent may be applied to the tool used for embossing, so that the tool used for embossing does not adhere to the reshapeable caul sheet 14.

Next, the method 400 may comprise the steps of placing the composite material 12 onto the rigid forming tool 16, as depicted in block 410, placing the reshapeable caul sheet 14 in the deformed configuration and the rigid state onto or against the composite material 12, as depicted in block 412, and covering the reshapeable caul sheet 14 with the release film 18, the breather 20, and/or the impermeable membrane 22, as depicted in block 414. In some embodiments of the invention, the release film 18 and/or the breather cloth 20 may be omitted without departing from the scope of the invention. The method 400 may then include the step of sealing the impermeable membrane 22 to the rigid forming tool 16, as depicted in block 416, creating a substantially airtight chamber between the rigid forming tool 16 and the impermeable membrane 22.

The method 400 may further comprise the step of pulling resin through the resin inlet toward the vacuum outlet, as depicted in block 418. Specifically, the resin inlet and/or the vacuum outlet may be opened, and/or the vacuum source may be turned on, such that the resin is pulled through the resin inlet in a direction toward the vacuum outlet and evenly dispersed across the composite material 12 between the reshapeable caul sheet 14 and the composite material 12. Temperatures at which the resin infuses the composite material 12 in step 418 may be less than the temperature T_{g} at which the reshapeable caul sheet 14 changes from the rigid state to the malleable state.

After the resin is dispersed across the composite material, the method 400 may include curing the composite material 12 under heat and pressure, as depicted in block 420. Specifically, the resin inlet may be closed, allowing the impermeable membrane to compress the composite material 12 against the rigid forming tool 16. Furthermore, the composite material 12 may be heated in an autoclave or oven to a requisite composite cure temperature for a required length of time. The cure temperatures may be at least high enough to trigger the reshapeable caul sheet 14 back to the malleable state. Specifically, the cure temperatures may be equal to or higher than T_{g}. At these temperatures, the reshapeable caul sheet 14 may return to its memory shape having a smooth surface, such that a surface of the resulting composite part contacting the reshapeable caul sheet 14 remains smooth after cure. This advantageously allows a surface of the finished composite part contacting the reshapeable caul sheet 14 to have a smooth finish, instead of the rough finish provided by prior art flow media used in prior art VARTM methods.

### Embodiment 2

### Reshapeable Forming Tool

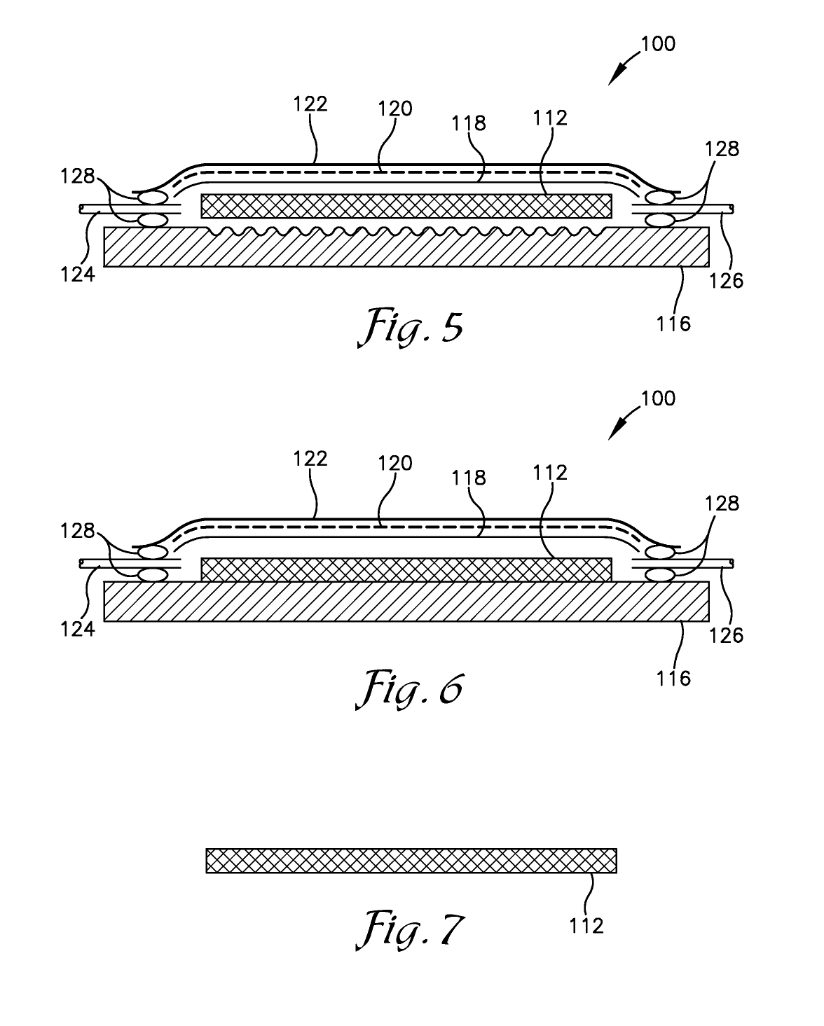

In another embodiment of the invention, as illustrated in FIGS. 5-8, a VARTM system 110 may comprise a reshapeable forming tool 116 made of shape memory polymer (SMP) material and/or a reshapeable thermoplastic material, as well as a release film 118, a breather 120, and an impermeable membrane 122, also referred to as a vacuum bag. The release film 118, breather 120, and impermeable membrane 122 may be substantially identical to the release film 18, breather 20, and impermeable membrane 22, respectively, as described above. The VARTM system 110 may further comprise a resin inlet 124, a vacuum outlet 126, and/or adhesive tape 128, which may be substantially identical to the resin inlet 24, vacuum outlet 26, and adhesive tape 28, respectively, as described above. In some embodiments of the invention, a traditional caul sheet (not shown) may also be used between a composite material 112 and the release film 118 without departing from the scope of the invention. The composite material 112 may be substantially identical to the composite material 12 described above.

The reshapeable forming tool 116 may have the same properties as the reshapeable caul sheet 14 of the previous embodiment, but may require a memory shape corresponding to a tool-side surface of the resulting composite part. However, the memory shape of the reshapeable forming tool 116 must still be substantially smooth, such that the resulting composite part formed thereby may also have a substantially smooth surface. In some embodiments of the invention, the reshapeable forming tool 116 may be a mandrel, such as an SMP mandrel, with channels or texture embossed into a surface thereof. In other embodiments of the invention, the reshapeable forming tool 116 may have any shape and/or curvature required for a given composite part being manufactured thereon.

In this embodiment of the invention, the reshapeable forming tool 116 may be provided with a deformed configuration by embossing or otherwise forming a rough, texturized, wavy, crisscrossed, zigzagged, or other non-smooth pattern having indentions and/or protrusions into a surface of the reshapeable forming tool 116 while it is in the malleable state. The texture or channels formed into the reshapeable forming tool 116 may be sized so as to allow resin to flow over a surface of the composite material 112 without significant amounts of the composite material 112 entering the texture cavities or channels. The reshapeable forming tool 116 may remain in the non-smooth, deformed configuration when the SMP material is triggered back to its rigid state and during resin transfer, as described herein. During curing of the composite material 112, the reshapeable forming tool 116 may automatically return to its memory shape, and the rough surface of the deformed configuration may revert back to a smooth surface.

The traditional caul sheet may be of any caul sheet material known in the art. For example, the traditional caul sheet may comprise smooth metal plates, free of surface defects and of the same size and shape as the composite material 112 and used to contact the composite material 112 during the curing process to transmit normal pressure and provide a smooth surface on the cured composite part. Additionally or alternatively, the traditional caul sheet may be replaced with the reshapeable caul sheet 14 described above. In other embodiments of the invention, at least one of the traditional caul sheet, the release film 118, the breather 120, the impermeable membrane 122, and the adhesive tape 126 may be omitted and replaced with the reusable apparatus 10 described in U.S. Pat. No. 8,105,068, incorporated by reference herein in its entirety.

In use, a method of vacuum assisted resin transfer molding (VARTM) using the reshapeable forming tool 116 may generally include placing the composite material 112 onto the reshapeable forming tool 116 in the rigid state and in the non-smooth, deformed configuration, covering the composite material 112 with the impermeable membrane 122, and sealing the impermeable membrane 122 to the reshapeable forming tool 116, creating a substantially airtight chamber between the reshapeable forming tool 116 and the impermeable membrane 122. Then, the method may include a step of pulling resin through the resin inlet 124 into the airtight chamber via the vacuum outlet 126. Once the resin is evenly dispersed throughout the composite material 112, the method may include the step of curing the composite material 112 at a temperature at least high enough to trigger the reshapeable forming tool 116 back into the malleable state. Since the memory shape of the reshapeable forming tool 116 includes a smooth surface facing the composite material 112, the finished, cured composite part is also provided with a smooth surface via this curing step.

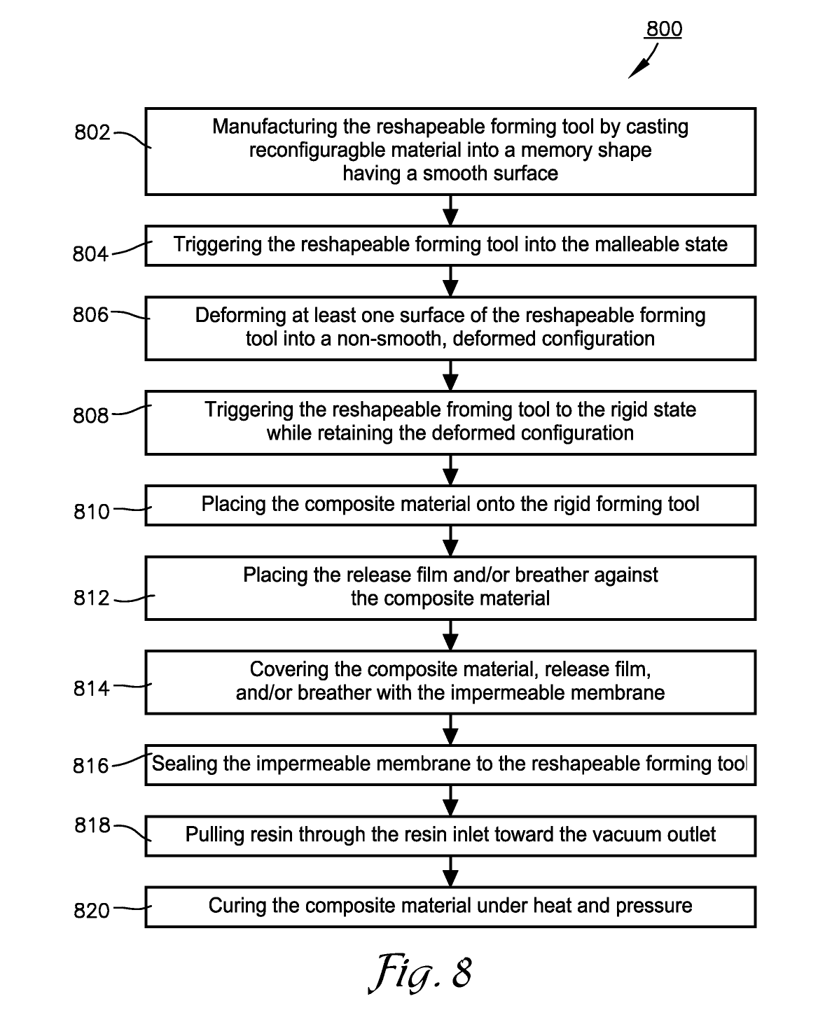

Method steps for resin-infusing and curing the composite material 112 with the reshapeable forming tool 116 will now be described in more detail. Specifically, FIG. 8 illustrates steps in a method 800 for forming a composite part using the reshapeable forming tool 116, in accordance with various embodiments of the present invention. The steps of the method 800 may be performed in the order as shown in FIG. 8, or they may be performed in a different order. Furthermore, some steps may be performed concurrently as opposed to sequentially. In addition, some steps may not be performed.

The method 800 of vacuum assisted resin transfer molding (VARTM) using the reshapeable forming tool 116 may include a step of manufacturing the reshapeable forming tool 116, as depicted in block 802, by casting the SMP material or the reshapeable thermoplastic materials into the memory shape having a smooth surface. Then, the method 800 may include the steps of triggering the reshapeable forming tool 116 into the malleable state, as depicted in block 804. As described above, for example, the SMP material may be heated above a trigger temperature T_{g}, placing the SMP material in the malleable state. While in this deformed state, the method 800 may include a step of deforming at least one surface of the reshapeable forming tool into the non-smooth, deformed configuration, as depicted in block 806. The non-smooth, deformed configuration may include a pattern, channels, or indentions molded, embossed, or otherwise formed into one or more surfaces of the reshapeable forming tool 116, as described above.

Then, the method 800 may include a step of triggering the reshapeable forming tool 116 into the rigid state while held in the non-smooth, deformed configuration, as depicted in block 808. For example, a tool used for embossing a texture or pattern of indentations into at least one surface of the reshapeable forming tool 116 while heated in the malleable state may remain pressed against the reshapeable forming tool 116 while the reshapeable forming tool 116 is cooled below T_{g}. Once the reshapeable forming tool 116 is completely rigid, the tool used for embossing may be removed away from the reshapeable forming tool 116. In some embodiments of the invention, a release agent may be applied to the tool used for embossing, so that the tool used for embossing does not adhere to the reshapeable forming tool 116.

Next, the method 800 may include the steps of placing the composite material 112 onto the reshapeable forming tool 116 in the rigid state and the non-smooth, deformed configuration, as depicted in block 810, covering the composite material 112 with the impermeable membrane 122, as depicted in block 814, and sealing the impermeable membrane 122 to the reshapeable forming tool 116, as depicted in block 816. The sealing step 814 may create a substantially airtight chamber between the reshapeable forming tool 116 and the impermeable membrane 122, with the exception of the resin inlet 124 and the vacuum outlet 126 formed therethrough. In some embodiments of the invention, the method 800 may also include placing the release film 118 and/or the breather 120 between the impermeable membrane 122 and the composite material 112, as depicted in block 812.

Then, the method 800 may include a VARTM step of pulling resin through the resin inlet 124 into the airtight chamber via the vacuum outlet 126 connected to a vacuum source, as depicted in block 818. Specifically, the resin inlet 124 and/or the vacuum outlet 126 may be opened, and/or the vacuum source may be turned on, such that the resin is pulled through the resin inlet 124 in a direction toward the vacuum outlet 126 and is evenly dispersed across the composite material 112 between the reshapeable forming tool 116 and the composite material 112. Temperatures at which the resin infuses the composite material 112 in step 818 may be less than the temperature T_{g} at which the reshapeable forming tool 116 changes from the rigid state to the malleable state.

After the resin is dispersed across the composite material 112, the method 800 may include the step of curing the composite material 112 at a temperature at least high enough to trigger the reshapeable forming tool 116 back into the malleable state, as depicted in block 820. Specifically, the resin inlet may be closed, allowing the impermeable membrane to compress the composite material 112 against the reshapeable forming tool 116. Furthermore, the composite material 112 may be heated in an autoclave or oven to a requisite composite cure temperature for a required length of time. As noted above, the cure temperatures may be at least high enough to trigger the reshapeable forming tool 116 back to the malleable state. Specifically, the cure temperatures may be equal to or higher than T_{g}. At these temperatures, the reshapeable forming tool 116 may return to its memory shape having a smooth surface, such that a surface of the resulting composite part contacting the reshapeable forming tool 116 remains smooth after cure, as illustrated in FIG. 7.

Both the reshapeable caul sheet 14 and the reshapeable forming tool 116 may be generally referred to herein as reconfigurable parts and provide several advantages over prior art flow media. For example, the reconfigurable part may be rough enough to allow resin to freely flow between the reconfigurable part and the composite material during resin infusion, but naturally becomes smooth enough when heated for cure that the resin does not remain trapped in cavities or channels thereof, as can occur with prior art flow media during cure. Furthermore, because the smooth memory shape provides a smooth surface for the cured composite part, no secondary sanding operations are required following curing of the composite part.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of vacuum assisted resin transfer molding, the method comprising:
assembling a substantially air-tight chamber around an uncured composite material, the substantially air-tight chamber having at least one impermeable membrane, at least one reconfigurable part in a rigid state, a resin inlet, and a vacuum outlet, wherein the at least one reconfigurable part has at least one surface in a non-smooth, deformed configuration placed against at least one surface of the composite material;
pulling resin from the resin inlet into the substantially air-tight chamber via the vacuum outlet; and
curing the composite material at a cure temperature sufficient to trigger the reconfigurable part into a malleable state, wherein the at least one surface of the reconfigurable part is configured to automatically return from the non-smooth, deformed configuration to a smooth configuration when triggered to the malleable state.

2. The method of claim 1, wherein the reconfigurable part is made of a shape memory polymer (SMP) material or reshapeable thermoplastic materials configured to remain in the rigid state at a temperature below glass transition temperature (T_{g}) and to transition to the malleable state at a temperature at or above T_{g}, wherein T_{g} is equal to or less than the cure temperature of the composite material.

3. The method of claim 2, further comprising a step of manufacturing the reconfigurable part by casting the SMP material or the reshapeable thermoplastic materials into a memory shape in which the at least one surface is smooth.

4. The method of claim 1, further comprising placing the at least one surface of the reconfigurable part in the non-smooth, deformed configuration by:
triggering the reconfigurable part into the malleable state;
deforming the at least one surface of the reconfigurable part into the non-smooth, deformed configuration; and
triggering the reconfigurable part back into the rigid state while maintaining the non-smooth, deformed configuration.

5. The method of claim 1, wherein the non-smooth, deformed configuration of the at least one surface of the reconfigurable part includes at least one of indentions, protrusions, a wavy texture, zigzag-patterned channels, and crisscrossed-patterns channels.

6. The method of claim 1, wherein the reconfigurable part is a reshapeable caul sheet, wherein the method further comprises placing the reshapeable caul sheet against the composite material prior to assembling the substantially air-tight chamber, wherein assembling the substantially air-tight chamber further comprises sealing the impermeable membrane to a rigid forming tool around the reshapeable caul sheet and the composite material.

7. The method of claim 1, wherein the reconfigurable part is a reshapeable forming tool, wherein the method further comprises placing the composite material onto the reshapeable forming tool in the deformed configuration, wherein assembling the substantially air-tight chamber further comprises sealing the impermeable membrane to the reshapeable forming tool around the composite material.

8. The method of claim 1, further comprising placing at least one of release film and a breather between the impermeable membrane and the composite material or between the impermeable membrane and the reconfigurable part.

9. A method of vacuum assisted resin transfer molding, the method comprising:
triggering a reshapeable caul sheet into a malleable state;
deforming at least one surface of the reshapeable caul sheet into a non-smooth, deformed configuration;
triggering the reshapeable caul sheet into a rigid state while in the non-smooth, deformed configuration;
placing composite material onto a rigid forming tool;
placing the reshapeable caul sheet in the non-smooth deformed configuration and the rigid state against the composite material;
covering the reshapeable caul sheet and the composite material with an impermeable membrane;
sealing the impermeable membrane to the rigid forming tool, creating a substantially air-tight chamber between the rigid forming tool and the impermeable membrane, the substantially air-tight chamber including a resin inlet and a vacuum outlet;
pulling resin from the resin inlet into the substantially air-tight chamber via the vacuum outlet connected to a vacuum source; and
curing the composite material at a temperature at least high enough to trigger the reshapeable caul sheet back into the malleable state, wherein the reshapeable caul sheet has a memory shape including a smooth surface facing the composite material, wherein the reshapeable caul sheet is configured to automatically return from the non-smooth,
deformed configuration to the memory shape when triggered to the malleable state.

10. The method of claim 9, wherein the reshapeable caul sheet is made of a shape memory polymer (SMP) material or reshapeable thermoplastic materials configured to remain in the rigid state at a temperature below glass transition temperature (T_{g}) and to transition to the malleable state at a temperature at or above T_{g}, wherein T_{g} is equal to or less than the cure temperature of the composite material.

11. The method of claim 10, further comprising a step of manufacturing the reshapeable caul sheet by casting the SMP material or the reshapeable thermoplastic materials into the memory shape having the smooth surface.

12. The method of claim 9, wherein the non-smooth, deformed configuration of the at least one surface of the reshapeable caul sheet includes at least one of indentions, protrusions, a wavy texture, zigzag-patterned channels, and crisscrossed-patterns channels.

13. The method of claim 9, wherein the step of deforming the at least one surface of the reshapeable caul sheet into the non-smooth, deformed configuration comprises embossing a pattern into the at least one surface.

14. The method of claim 9, further comprising placing at least one of release film and a breather between the impermeable membrane and the reshapeable caul sheet.

15. A method of vacuum assisted resin transfer molding, the method comprising:
triggering a reshapeable forming tool into a malleable state;
deforming at least one surface of the reshapeable forming tool into a non-smooth, deformed configuration;
triggering the reshapeable forming tool into a rigid state while in the non-smooth, deformed configuration;
placing composite material onto the reshapeable forming tool in the rigid state and the non-smooth, deformed configuration;
covering the composite material with an impermeable membrane;
sealing the impermeable membrane to the reshapeable forming tool, creating a substantially airtight chamber between the reshapeable forming tool and the impermeable membrane, the airtight chamber further including a resin inlet and a vacuum outlet;
pulling resin from the resin inlet into the airtight chamber via the vacuum outlet connected to a vacuum source; and
curing the composite material at a temperature at least high enough to trigger the reshapeable forming tool back into the malleable state, wherein the reshapeable forming tool has a memory shape including a smooth surface facing the composite material, wherein the reshapeable forming tool is configured to automatically return from the non-smooth, deformed configuration to the memory shape when triggered to the malleable state.

16. The method of claim 15, wherein the reshapeable forming tool is made of a shape memory polymer (SMP) material or reshapeable thermoplastic materials configured to remain in the rigid state at a temperature below glass transition temperature (T_{g}) and to transition to the malleable state at a temperature at or above T_{g}, wherein T_{g} is equal to or less than the cure temperature of the composite material.

17. The method of claim 16, further comprising a step of manufacturing the reshapeable forming tool by casting the SMP material or the reshapeable thermoplastic materials into the memory shape having the smooth surface.

18. The method of claim 15, wherein the non-smooth, deformed configuration of the at least one surface of the reshapeable forming tool includes at least one of indentions, protrusions, a wavy texture, zigzag-patterned channels, and crisscrossed-patterns channels.

19. The method of claim 15, wherein the step of deforming the at least one surface of the reshapeable forming tool into the non-smooth, deformed configuration comprises embossing a pattern into the at least one surface.

20. The method of claim 15, further comprising placing at least one of release film and a breather between the impermeable membrane and the composite material.
